(19) United States
(12) Patent Application Publication
(10) Pub. No.: US 2015/0338728 A1
(43) Pub. Date: Nov. 26, 2015

(54) SYSTEM AND METHOD FOR CONTINUOUSLY PROJECTING A REFERENCE AID AT AN ACTIVITY SITE

(71) Applicant: THOUGHT DEVELOPMENT, INC., Miami Beach, FL (US)

(72) Inventor: Alan Amron, Miami Beach, FL (US)

(73) Assignee: THOUGHT DEVELOPMENT, INC., Miami Beach, FL (US)

(21) Appl. No.: 14/286,876

(22) Filed: May 23, 2014

(51) Int. Cl. G03B 21/20; G01B 11/26

(52) U.S. Cl. CPC G03B 21/2053; G03B 21/2033; G01B 11/26

(57) ABSTRACT

An apparatus and method for projecting reference aids at sites characterized by continuous activity over periods which long enough to encompass both full daylight and artificial light only ambient lighting conditions. Variations in ambient light intensity are detected over the course of the activity period, and at least one laser projection system is operated responsive to the detecting to project a line which is visible continuously throughout the site activity period. The projected line serves as a reference aid for guiding operation of vehicles and equipment as they approach or depart a particular processing station of the site.

### BACKGROUND OF THE INVENTION

1. Field of the Invention

The present invention relates generally to the projection of visible lines and other useful markings onto a surface and, more particularly, to systems employing one or more lasers to project such markings upon a surface.

2. Description of the Related Art

To maximize production output, certain work site activities may take place on a continuous (i.e. “round-the-clock”) basis. Such is the case, in particular, in those activities driven by high capital investment, in which the equipment used is very specialized and acquired at high cost. At a mining site, for example, it is not uncommon for large dump trucks to shuttle back and forth between the same two stations many times over the course of a day, and for these trucks to be operated in shifts so that they are always in use (other than for refueling or maintenance). At one location, a load of ore may be dumped into the bed of the truck. At another, the load is dumped into a crushing pit. This circuit is repeated many times throughout the course of a 24-hour day, by each of a plurality of trucks, with the steady stream of ore being needed to feed a continuous processing operation which, if interrupted, results in lost productivity and in lost profits to the mine operator/owner.

The inventor herein has observed that vehicles approaching a site of the type exemplified above are operated by highly skilled drivers. However, even for such drivers, it is a challenge to properly align the vehicle perfectly, the first time, every time. The risk of damaging adjacent structures or equipment is ever present. While guiding markers could theoretically be used, these are subject to damage and would restrict movement of vehicles and equipment in the vicinity of the discharge station or other facility being approached. Paint applied directly to the surface, on the other hand, would quickly deteriorate and/or be obscured by shifting sand, rocks or dirt.

A need therefore exists for a system and method for providing a visible reference aid to guide vehicles and equipment at an activity site characterized by continuous operation.

A further need exists for a system and method for providing such a reference aid in a manner which is both safe and not susceptible to variations in ambient daylight over the course, for example, of one or more cycles of 24 hour operation.

### SUMMARY OF THE INVENTION

The aforementioned needs are addressed, and an advance is made in the art, by an apparatus for continuously providing at least one visible line for the duration of a site activity period, wherein the projected visible is usable as a reference aid throughout the site activity period despite dynamically variable ambient lighting conditions. Embodiments of the system include at least one laser source operative to direct optical energy at a wavelength of between 380 nm and 750 nm upon a surface proximate a first site location and an ambient light sensor dimensioned and arranged to detect variations in an intensity of sunlight at the first site location so as to approximate an intensity of sunlight striking the surface. Each laser source includes one or more lasers operated a power level of 10 to 100 W each, and either in tandem such that their output is combined or in a prescribed sequence, so that less than all of a plurality of lasers (i.e., a subset) are operated at any given interval within the site activity period.

A computer, which includes a processor and a memory, is operatively associated with the ambient light sensor, the processor being operative to execute instructions stored in memory to select, responsive to detected changes in ambient light intensity, any of a same, decreased and increased laser power output in order to continuously maintain visibility of a projected line for the duration of the site activity period. A laser controller is operatively associated with the at least one laser and, according to embodiments of the invention, is communicatively coupled to the computer. The laser source controller is operative to modulate an output of the at least one laser source responsive to commands from the computer to any of maintain, decrease or increase an output of the at least one laser source.

A computer implemented method for continuously projecting a reference aid over the course of an activity period is also described. The method comprises receiving, at a computer controlled laser projection system, a request to project at least one line extending from a first site location, over a site activity period, as a reference aid for use in at least one of approaching and departing the first site location. The method further comprises detecting variations in ambient light intensity during the site activity period, and operating at least one laser source of the laser projection system, responsive to the detecting, to project a lane which is visible continuously throughout the site activity period.

According to embodiments, the site activity period is at least 24 hours and the operating is performed continuously over the site activity period and under ambient operating conditions ranging from full daylight to artificial light only. Disruption of operation occurs only if a manual override is actuated, or an unsafe condition such as a dangerous level of explosive vapor in the atmosphere or a level of vibration indicative of an explosion or other even disruptive to continued processing operations at the site location. While the system is in use, vehicles and equipment are operated by reference to the projected line to situate them at a desired location relative to a work site processing facility or other work site location.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a block diagram depicting the various functional elements of an embodiment of a reference aid projecting system deployed at an exemplary activity site which includes three site locations.

FIG. 2 is a block diagram depicting the various functional components of the reference aid projecting system of FIG. 1;

FIG. 3 is a block diagram depicting the deployment of a reference aid projecting system at a processing station of a mining site, according to an embodiment;

FIG. 4 is a block diagram depicting the construction of an exemplary laser projector as part of a laser projection system in accordance with embodiments;

FIG. 5 is a flow chart depicting steps of operating embodiments of a laser projecting system to provide a continuous reference;

FIG. 6 is a flow chart depicting, in greater detail, a series of steps which may be performed as part of the exemplary process of FIG. 5 according to some embodiments;

FIG. 7 is a flow chart depicting, in greater detail, a series of steps which may be performed as part of the exemplary process of FIG. 5 according to some embodiments; and

FIG. 8 is a flow chart depicting, in greater detail, supplemental steps which may be carried out as part of the illustrative process of FIG. 5 according to some embodiments.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “laser source” is intended to refer both to arrangements in which a coherent laser beam source and beam projecting optics are integrated into a single housing at a common mounting location and to arrangements in which the laser source itself consists of optical beam collimating, diffusing and/or scanning elements configured to receive, via a waveguide (e.g., optical fiber), the output of a remotely located laser source. The term “laser sources” should also be understood to encompass other line forming arrangements besides those which rely upon beam diffusing elements such as lenses, including for example, the movement of mirrors to implement a “scanning” operation.

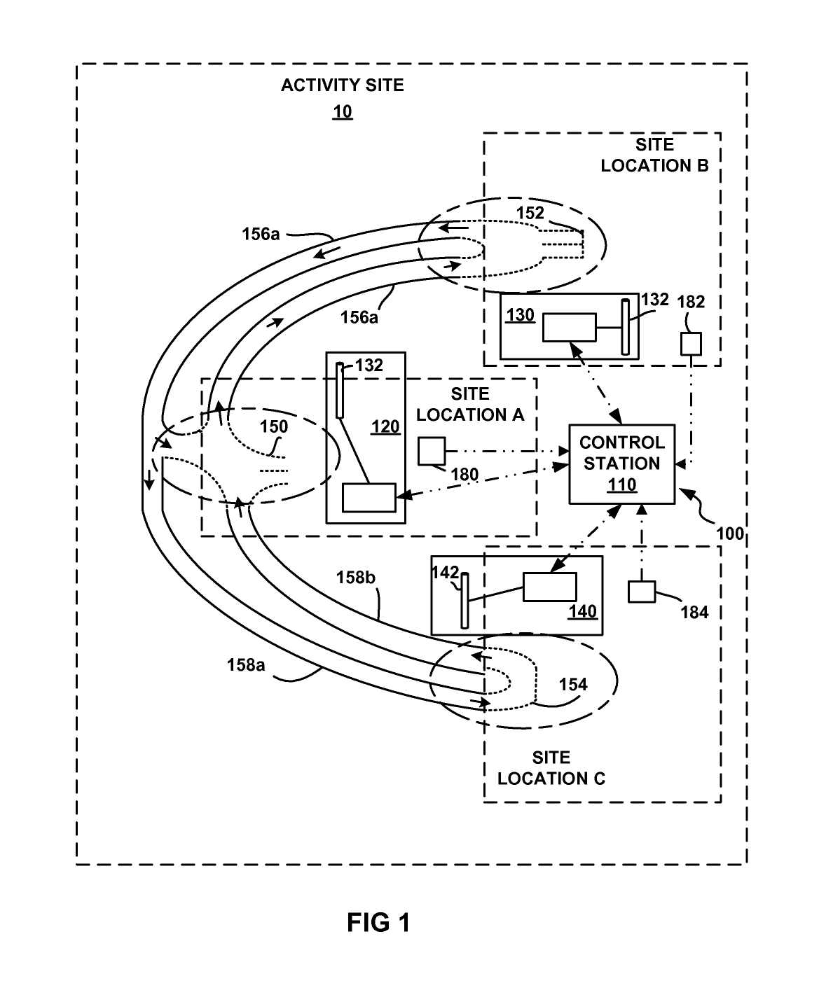

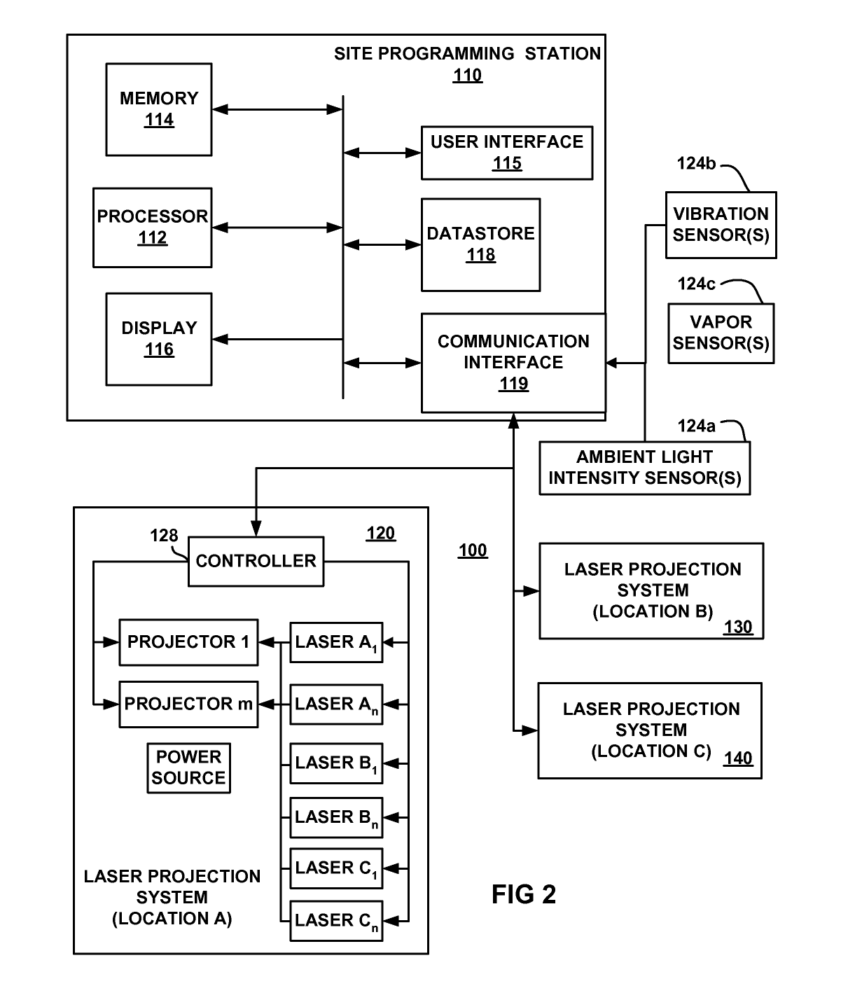

With initial reference to FIG. 1, there is shown a block schematic diagram depicting a continuous aid reference marker projecting system 100 operative to provide at least one reference line at each of a plurality of site locations at activity site 10. Three of these site locations—indicated generally at Site Location A, Site Location B, and Site Location C—are shown in FIG. 1. According to embodiments, system 100 includes a central site control station (computer) 110 which is communicatively coupled to a plurality of laser projecting systems including laser projecting systems 120, 130 and 140 disposed at Site Locations A, B and C, respectively. Components of each of laser projecting systems 120, 130 and 140 include a laser controller and one or more lasers (FIG. 2) as well as a projector indicated generally at reference numerals 122, 132 and 142, respectively. A plurality of sensors, as sensors 124, 134 and 144 disposed at one or more locations within each of the site locations having a laser projection system, provide input to central site control station 110.

According to some embodiments, at least one of the sensors is a commercially available ambient light intensity sensor, operating on the principles of devices used by photographers to detect lighting levels during photography sessions. The ambient light sensors are operative to detect variations in the amount of light at the site location over the course of an activity period. While an activity period may vary in duration, and may be interrupted for such reasons as scheduled maintenance, unanticipated equipment failure, or safety reasons, embodiments of the invention are operative to project a visible line for extended periods of time which may range from a few hours to a few days to a few weeks and even to months or years of uninterrupted operation. During night time (artificial light only) operation, a much smaller amount of laser output is required. In full daylight, on the other hand, the full output of several lasers may be required to generate a reference aid bright enough to be seen. Responsive to input provided by ambient light sensors located at each site location, the output of each laser projecting system as system 120 is adjusted so that a visible light is generated at all times. According to some embodiments, such dynamic adjustment comprises selecting one of a plurality of output levels according to whether the detected level of ambient light intensity falls within a range associated with the selected level.

According to some embodiments, projectors 122, 132 and 142 are configured with movable x-y scanning heads so, for example, that the complex lane pattern as patterns 150, 152 and 154 shown at Site Locations A, B and C of FIG. 1, respectively, are defined. In this regard, an entire site routing plan, including lanes 156a, 156b, 158a and 158b can also be defined using additional laser projecting systems (not shown) to the extent one or more of the site locations is subject to relocation and/or alteration. By designing and projecting inter-station routes immediately after relocating a processing station or otherwise altering a site flow, transitional periods which might otherwise be characterized by higher latency, higher fuel costs and/or a higher accident rate are substantially avoided. After equipment and vehicle operators become accustomed to the new flow, operation can (though it need not) be limited to just the processing locations themselves.

According to some embodiments, projectors 122, 132 and 142 utilize one or more scanning projector and control arrangement of the type disclosed in U.S. Pat. No. 7,219,438 entitled SYSTEM FOR OPERATING ONE OR MORE SUSPENDED LASER PROJECTORS TO PROJECT A TEMPORARY VISIBLE IMAGE ONTO A SURFACE. Closed-loop galvanic scanners (also called “position detecting” scanners), for example, are commonly used in the laser light entertainment industry and are capable of directing a beam to 24,000 to 30,000 discrete points along a selected path every second.

With particular reference now to FIG. 2, elements of illustrative system 100 are shown in greater detail. According to embodiments, site programming station 110 is implemented as a general purpose computer and comprises a processor 112, a memory 114, a user interface 115, a display 116, a data store 118 and a communication interface 119.

As noted previously, a purpose of station 110 is to control the operation of the respective laser projector systems 120, 130 and 140 responsively to inputs received from a plurality of sensors as sensors. Electrical signals representative of the detected sensor values are received at communication 119. According to some embodiments, these signals are wirelessly transmitted by at least some of the sensors, with each sensor having a unique identifier such as a media access control (MAC) address or other means of identifying itself to control station computer 110. An exemplary ambient light intensity sensor 124a associated with Site Location A is shown in FIG. 2.

Processor 112 executes instructions stored in memory leading to a comparison between a detected ambient light value and a series of reference ranges stored in datastore 118. According to some embodiments, each reference range represents that range of detected ambient light values at which one or more lasers operated individually or in combination produce a reference aid of sufficient visibility as to be useful to vehicle and equipment operators. According to other embodiments, a set of operating set points corresponding to a performance curve may be fixed by software, wherein this operating curve is used as the reference by which the output of each laser or each laser source is modulated with respect to time. As will be readily appreciated by those skilled in the art, the sensory input is not required during times of artificial lighting (i.e., after sundown and before sunrise) so dynamically variable operation according to a sensory input approach, as exemplified above, is preferably suspended during such times.

According to some embodiments, the processor 112 of control station computer 110 is responsive to input from light intensity sensors as sensor 124a, at Site Location A, to immediately disable the output of the associated laser projection system 120 when a reduction in the intensity of ambient light is so rapid as to cause the pupil of the average human eye to dilate sufficiently to expose that eye to levels of visible laser radiation in excess of the accessible emission limits contained in Table II of 21 CFR Subchapter J Part 1040.10 (i.e., above the threshold for Class IIIa mode of operation under rules promulgated by the U.S. Center for Devices and Radiological Health.

Other types of sensors which may be processed by processor 112 of station 110 include vibration sensors and vapor sensors 124b and 124c, respectively, associated with Site Location A. When a level of vibration indicative of an explosion is detected by sensor 124b, which is predictive of a disruption in operation, an unsafe operating condition, or a strong possibility of system component misalignment, control station computer 110 instructs the laser projection systems affected by the condition to shut off until the issue is resolved. Likewise, vapor sensor 124c is configured to characterize and determine the level of explosive vapors in the atmosphere surrounding a site location as Site Location A (FIG. 1). If this level is above the lower explosive limit (LEL) or below the upper explosive limit (UEL) and therefore indicative of an unsafe operating environment, control station computer 110 transmits a signal to corresponding laser projection system 120 and causes the system 120 to shut down until the issue is investigated and/or resolved.

It will be recalled that in the embodiment depicted in FIG. 1, a movable projector—allowing the projection of complex site location routing patterns to be defined—is contemplated. To define such patterns, instructions are stored in memory 114 and executable by processor 112 to allow the system operator to define the pattern associated with site location. User interface 115 and display 116 may be used for this purpose or, optionally, a mobile terminal such as a laptop, notebook or tablet computer operative to exchange communication signals with control station computer 110 via interface 119 can be used so that the pattern being defined can be viewed in real time while the operator is standing at the applicable site location being programmed.

With continued reference to FIG. 2, it will be seen that each laser projection system as system 120 can include one projector or multiple projectors as projectors 1 to m, a plurality of lasers as lasers A₁ to Aₙ, B₁ to Bₙ, and C₁ to Cₙ and a power source for supplying power to all of these various components. According to some embodiments, one or more lasers and a projector constitute a single laser source. According to the embodiment of FIG. 2, any laser or group of lasers among lasers A₁ to Aₙ, B₁ to Bₙ, and C₁ to Cₙ is operative to feed any one or all of projectors 1 to m.

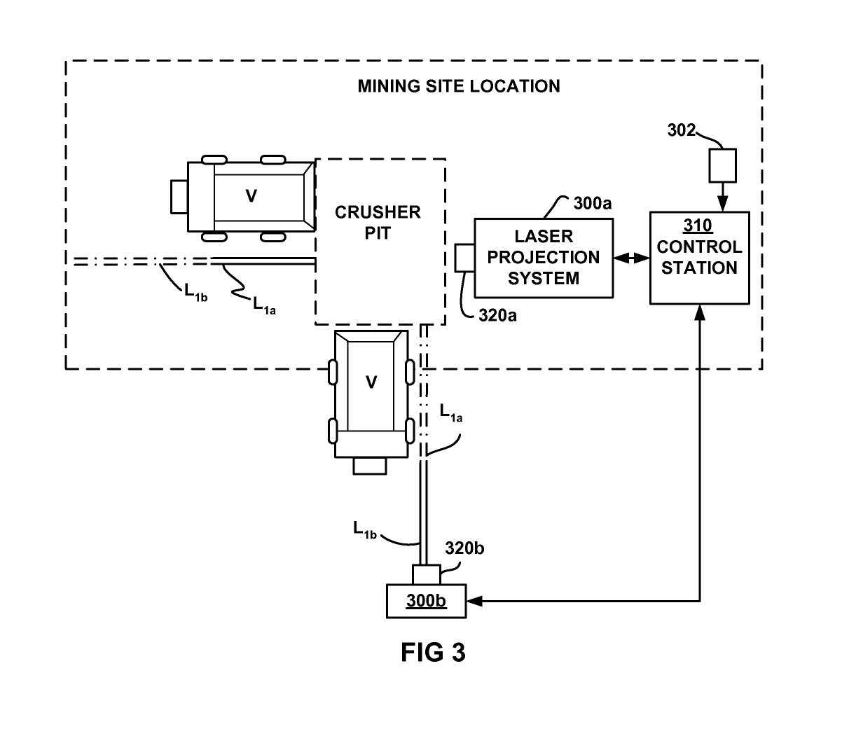

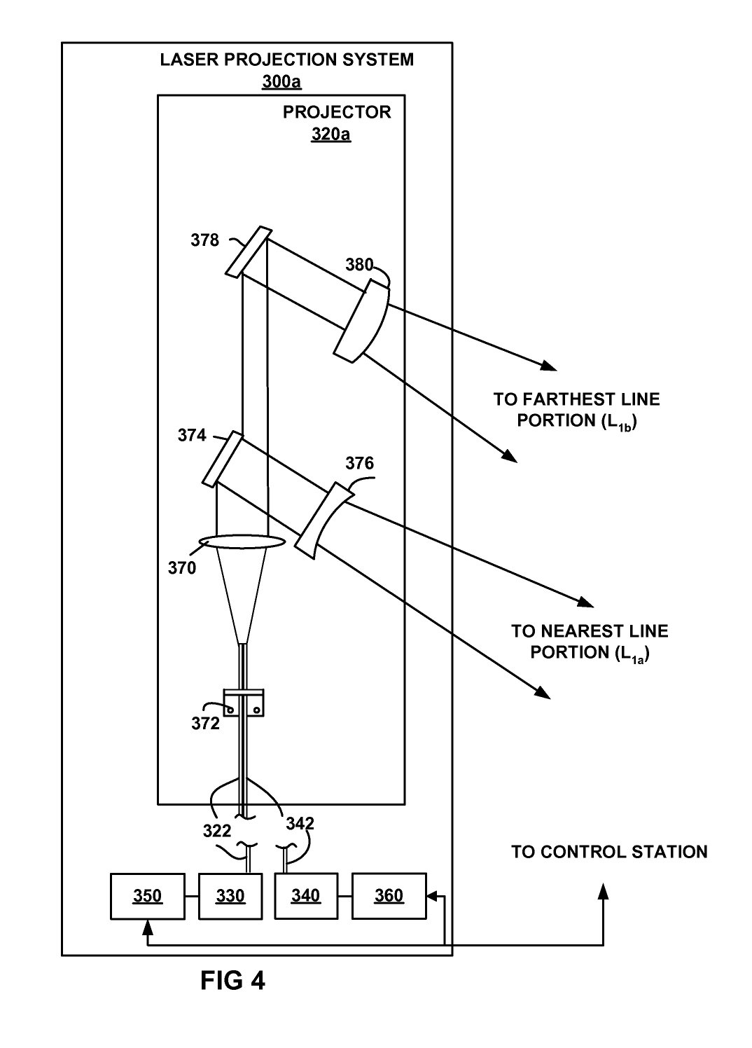

Multiple projectors as shown in FIG. 2 are especially suited for complex reference aid shapes and lane patterns, particularly when bi-directional paths are to be defined in manner depicted in FIG. 1. For reference aids comprising only a single line, however, a single projector with stationary components (i.e., without moving parts) may be coupled to each of one or a plurality of lasers by corresponding optical fibers. An embodiment of the latter will now be described with particular reference to FIGS. 3 and 4.

FIG. 3 depicts a specialized site location of a mining activity site. In the illustrative embodiment, the site location is an ore processing facility which includes a crusher pit. Before a large dump vehicle V can empty the contents of its bed into the crusher pit, it must approach and back into the correct location without damaging any of the adjacent equipment or other portions of the facility. A preferred alignment requires a longitudinal axis of the vehicle V to be orthogonal to the sidewall of the pit. According to embodiments of the invention, this alignment is achieved by reference to one or more simple reference lines as reference lines L₁ and L₂ projected by laser projection systems 300a and 300b, respectively. One or more sensors as ambient light sensor 302 provide input to control station computer 310. In all material aspects, the construction and programming of control station computer 310 is the same as that described in connection with control station 110 of FIGS. 1 and 2 except to the extent that the projectors 320a and 320b are not of the scanning type and therefore do not permit the rendering of complex line and lane patterns (of the type shown in FIG. 1).

An exemplary projector useful, yet simple, reference aids according to embodiments is disclosed in FIG. 4. In this example, laser projection system 300a includes a fiber fed projector 320a which receives the output of two lasers 330 and 340 is via first and second optical fibers, indicated generally at reference numerals 332 and 342, respectively. Each laser is, in turn, operated by a corresponding laser controller 350 and 360, respectively. Each of laser controllers 350 and 360 are communicatively coupled to and under the operative control of projector control station 310. It should be noted that although the functions of the control station 310 and laser controllers 350 and 360 are described in connection with one embodiment as being separately performed by a distributed network of communicatively coupled modules, it should be readily appreciated by those skilled in the art that in other embodiments appropriate hardware can be incorporated into computer 310 to perform any and all of the functions typically performed by a laser controller such, for example, as power on, power off, diagnostics, and power level modulation.

In any event, and with continued reference to FIG. 4, it will be seen that according to some embodiments, projector 320a includes a biconcave, collimating lens 370 which receives the output of lasers 330 and 340 via fibers 332 and 342. The fibers are maintained in a precise registration with collimating lens 370 by a retaining block 372 mounted within a projector housing. A portion of the collimated beam emitted by lens 370 is reflected by a first or lower mirror 374 into a plano-convex lens indicated generally at reference numeral 376. The output of lens 376 which projects optical energy onto the ground to define the nearest portion of line L1 indicated generally at L₁ₐ in FIG. 3. The remaining portion of the output of the collimated beam output by lens 370 is reflected by a second or upper mirror 378 into a plano-concave lens 380 which projects optical energy onto the ground to define the farthest portion of the line L1 indicated generally at L_{1b} in FIG. 3. Projector 300b is constructed in like fashion.

It will, of course, be readily appreciated by those skilled in the art that a variety of other projection module mounting configurations are possible besides those exemplified by FIGS. 1-4.

For a line width of approximately 4″ inches, excellent results in full daylight ambient lighting conditions have been achieved using two lasers each operated at 50 W. Suitable lasers include frequency doubled, Q-switched Nd:YAG laser adapted to generate laser pulses at a wavelength of 532 nm. Emission at this wavelength is especially preferred since it is very close to the peak (555 nm) of the human eye's sensitivity. By comparison, in an argon ion laser operating in continuous wave (cw) mode, roughly half of the output is at 514 nm (58% as bright as the same beam at 555 nm), another 30% is at around 480 nm (18% as bright) and the remaining 20% is at around 440 nm (barely visible to the human eye). Thus, an argon laser would theoretically have to deliver up to three or four times as much power to match the visibility of the Nd:YAG laser.

With simultaneous reference now to FIGS. 1, 3 and 7, a process for utilizing a continuous reference aid projecting system in accordance with novel methods of operation will now be described. The process 500 is entered at block 502 wherein one or more projection systems constructed in accordance with embodiments of the invention have been installed at one or more activity site locations and these have been communicatively coupled to and are operative under the direction of a control station computer configured to receive input from one or more sensors located at one or more of the activity site locations. At block 504, a request is received to continuously project at least one line at an activity site for the duration of an activity period. The period activity may be of finite duration (i.e. specified in the request) or of infinite duration (subject only to manual override by an operator or an interruption in operation due to power loss or the detection of an unsafe operating condition or other specifiable event).

At block 506, the method energizes one or more laser sources are energized (as lasers A₁ to Aₙ of FIG. 2 or lasers 330 and 340 of FIG. 4) and at block 508. The process then proceeds to decision block 510. If a substantial enough change in the level of ambient light is detected, such that a change in operation is required to maintain visibility and/or minimize power consumption (i.e. an ambient lighting measurement is received from a sensor which is brighter or dimmer than the preceding measurement interval), then at block 512 the output of the applicable laser source(s) is/are modified. Otherwise, the method proceeds to decision block 514. If an interruption event is detected, then at block 516, operation is suspended for the duration of the interruption event. Otherwise, the process proceeds to decision block 518. If no end point was specified in the request received at block 504, the process returns to block 508. If an endpoint was specified, the process proceeds to decision block 520. If the specified endpoint has been reached, the process terminates at block 522. Otherwise, the process returns to block 508.

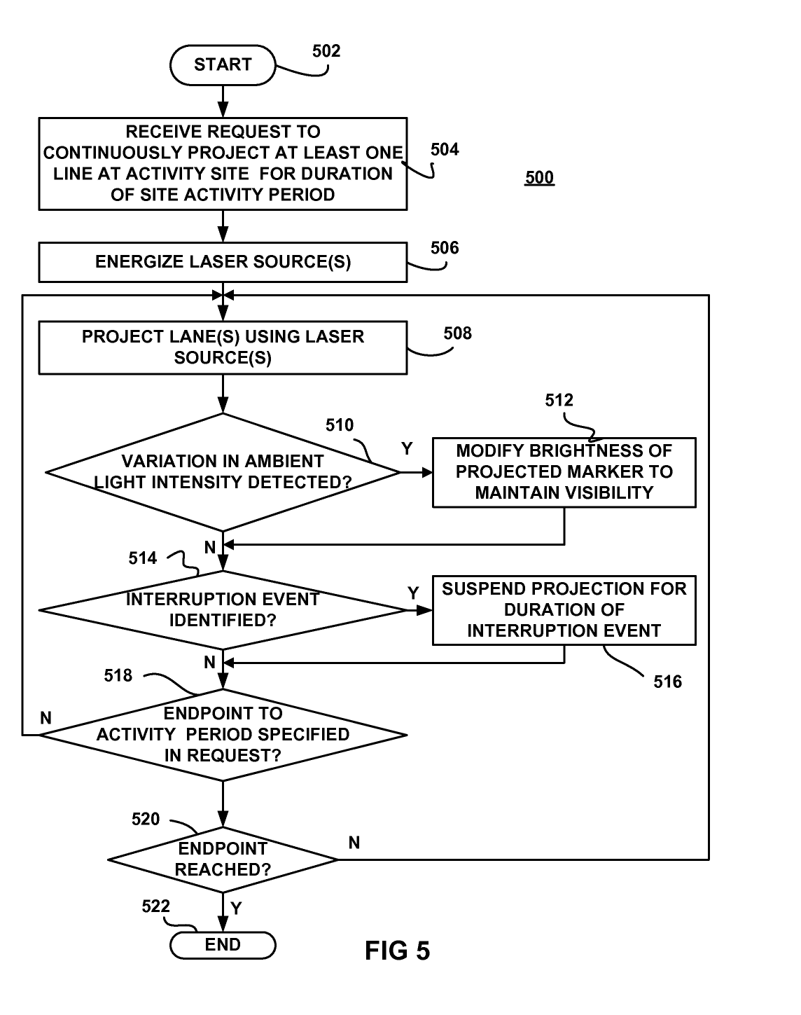

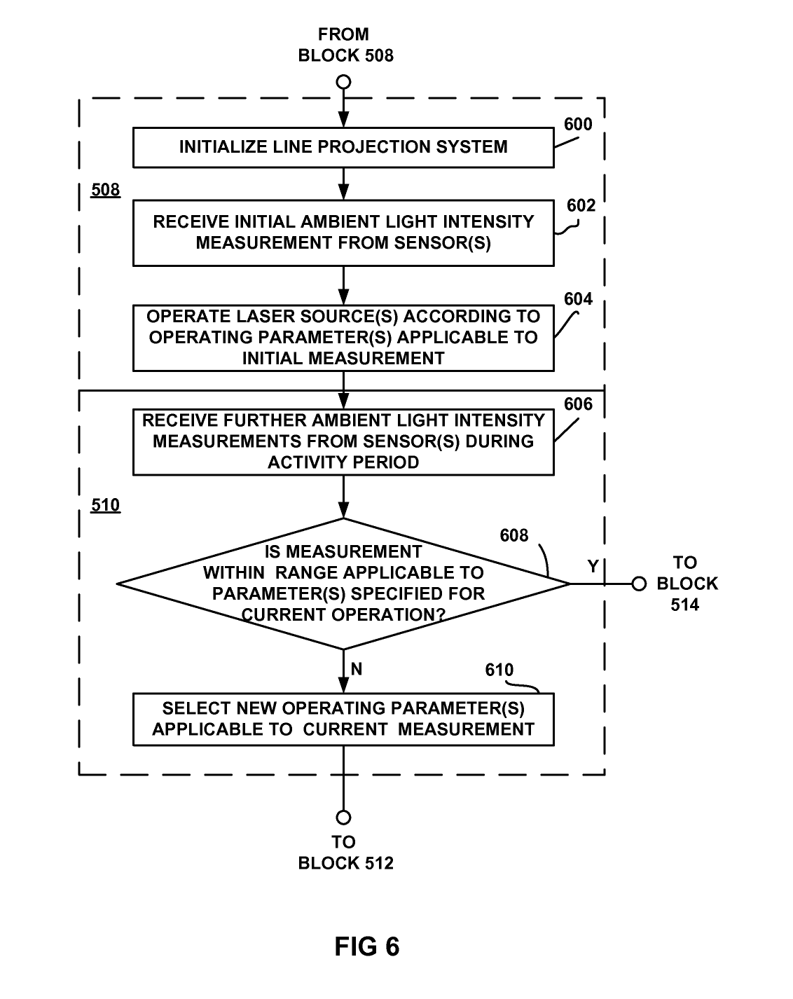

Turning now to FIG. 6, an embodiment of the illustrative process of FIG. 5 is depicted in greater detail, with particular emphasis on blocks 508, 510, and 512. According to embodiments, block 508 encompasses, at block 600, a step of initializing the line projection system. Typically, this includes performing a self diagnostic test to verify that all components essential to safe operation are in proper working order. Such components include the sensors, the signaling interfaces between control station computer 110 (FIG. 1-2) or 310 (FIGS. 3-4) and the respective laser controllers, and the like. An operator of the control station computer may be prompted to confirm proper operation at this time.

The process of block 508 proceeds to block 510, which includes sub process block 606, wherein an initial light intensity measurement is received and processed. According to some embodiments, a light intensity sensor may be present at each activity site location. Alternatively, a single light intensity sensor may be used. The measured value(s) is/are stored in the memory of the control station computer and, according to some embodiments, the computer processor selects an initial laser output power requirement based on the measurement(s).

In some embodiments, a respective, satisfactory power level is stored for a corresponding range of measured values. If the measurement(s) fall within one of these ranges, the applicable power level is selected for the laser(s) associated with at least the activity site location at which the sensor measurement was acquired. At sub-block 608 of block 510, as new ambient light intensity measurements are acquired, they are compared as described above to determine whether they are still within the range determined for the preceding interval. If so, the process returns to block 514 (FIG. 5). If not, the processor of the control station computer selects an updated power output level and sends a command or other signal to the applicable laser controller(s) to initiate laser operation at the selected, updated power output level. The process then proceeds to block 512 whereat the aforementioned command is processed and operation at the modified brightness level begins.

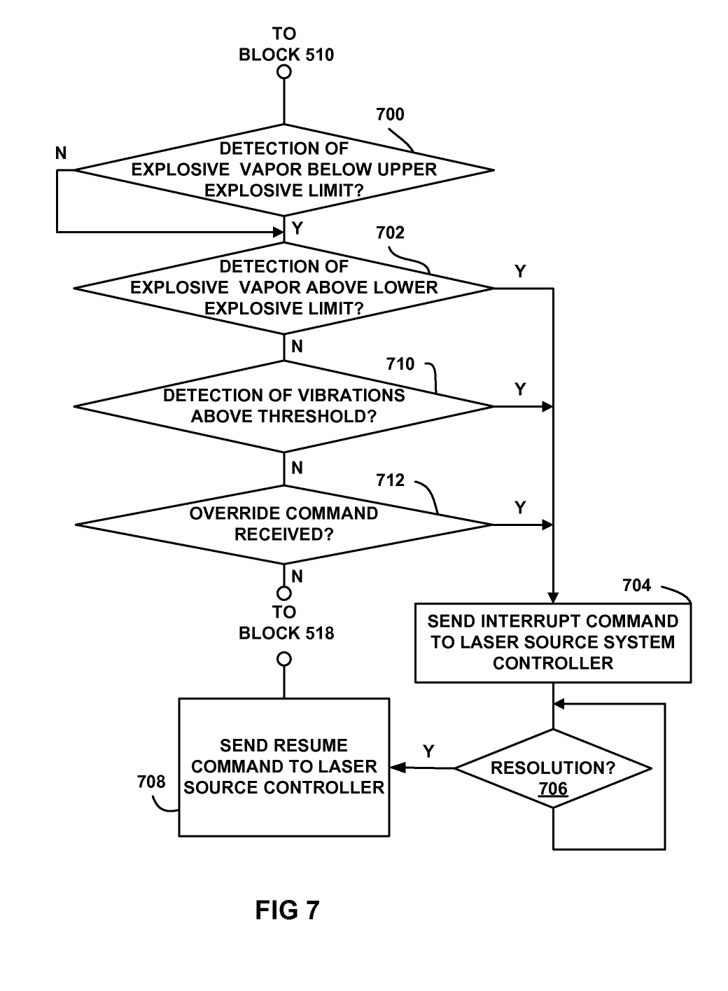

With reference now to FIG. 7, there is shown a series of optional steps associated with the identification and handling of interruption events as a sub-process within block 514 of FIG. 5 according to some of the embodiments of the invention. The sub-process begins at decision block 700, at which point a determination is made as to whether or not an explosive vapor is detected by one or more sensors to be at a level below the upper explosive limit. If so, a further determination is made at block 702 as to whether the explosive vapor is also present at a level above the lower explosive limit. Since operation in this range is highly dangerous, in the event the outcome of this determination is also yes, then the process proceeds to block 704. At block 704, an interrupt command is sent to the laser source controller(s) in the location of the sensor. Once the situation is resolved (at block 706), which may require confirmation by an operator or may be automatic based on an extended (say, for example 1 hour) period of readings below the lower explosive limit, a resume command is transmitted at block 708 to the laser source controller and operation resumes.

Returning to block 700, it should be noted that if a level of explosive vapor is detected which is above the upper explosive limit, this too may be processed by control station computer 110 or 310 (FIG. 2 or 4) to suspend operation the lasers and associated controllers. In any event, assuming no or only permissible amounts of an explosive vapor in the atmosphere, the process proceeds from either of blocks 700 and 702 to decision block 710. At decision block 710, if a vibration sensor at an activity site detects the existence of vibrations indicative of an unsafe operating environment such, for example, as an explosion or other accident, then the event is processed by the processor of computer 110 or 310 and all laser sources responsive to sending and processing of an interrupt event command at block 704 as above described. Likewise, at block 712, if an override command is received—whether by a local pushbutton operator at the location of the reference aid or by action of the control station computer operator—the interrupt event command is transmitted to the laser source(s) affected until the situation is resolved. If not interrupt events are detected or if the detected event(s) are resolved, then operation proceeds to block 518 of FIG. 5.

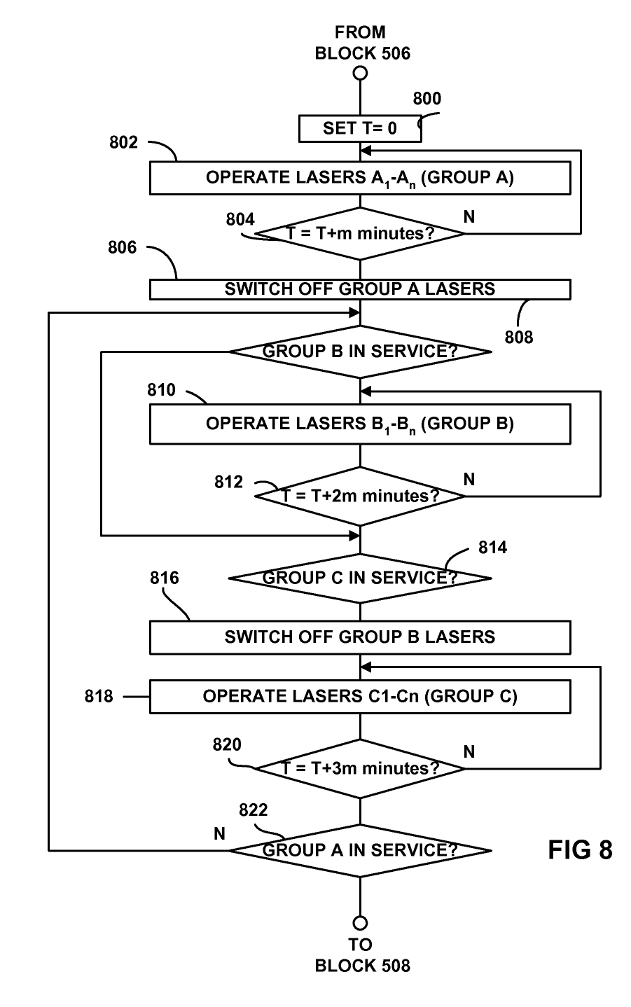

With final reference now to FIG. 8, there is shown optional arrangement for operating subsets of lasers in round-robin fashion as part of a reference aid projecting system according to embodiments of the invention. As seen in FIG. 8, which proceeds from block 506 of FIG. 5, an operating interval time T is initialized to zero at block 800 and at block 802, a first subset of lasers, as lasers A₁ to Aₙ of FIG. 2, are operated during a time T+m minutes. M may be any number and may, in fact be measured hours or days rather than in minutes. The objective is to provide redundancy and ensure the projection of a visible reference aid over an extended period of time. According to some embodiments, m is a period of between 60 and 6000 minutes (i.e. 1 to 100 hours). At decision block 804, it is determined whether operation of the first subset of lasers has been for m minutes and, if so, these are switched off at block 806 and a determination is made at block 808 whether a second subset (Group B) are operational. If so, these are then operated at block 810 for another m minutes. If the lasers of Group B are not determined to be operational at decision block 808, or after determination at block 812 that operation of those lasers has proceeded for m minutes, the process proceeds to block 814, at which point a determination is made as to whether the lasers of Group C are operational. If so, the lasers of group B are switched off at block 816, and operation of the lasers of Group C proceeds at block 818 until, at block 820, it is determined that these lasers have been operated for m minutes.

Continuing with the example of FIG. 8, if the lasers of Group C are not determined to be operational at decision block 814, or after determination at block 820 that operation of those lasers has proceeded for m minutes, the process proceeds to block 822, at which point a determination is made as to whether the lasers of Group A are operational. The process then proceeds to block 508 of FIG. 5 and is ready for the next cycle of operation.

While given components of the system have been described separately, one of ordinary skill also will appreciate that some of the functions may be combined or shared in given instructions, program sequences, code portions, and the like. The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer implemented method comprising:
receiving, at a computer controlled laser projection system, a request to project at least one line extending from a first site location, over a site activity period, as a reference aid for use in at least one of approaching and departing the first site location;
detecting variations in ambient light intensity during the site activity period;
operating at least one laser source of the laser projection system, responsive to the detecting, to project a lane which is visible continuously throughout the site activity period.

2. The method according to claim 1, further including aligning a vehicle with the at least one line so as to situate the vehicle at a desired location relative to the work site location.

3. The method according to claim 1, wherein the site activity period is at least 24 hours and wherein the operating is performed continuously over the site activity period and under ambient operating conditions ranging from full daylight to artificial light only.

4. The method according to claim 1, further including monitoring an atmosphere of laser source operation for a presence of explosive vapor.

5. The method according to claim 4, further including terminating the operation of the at least one laser source responsive to detection of at least one of an explosive vapor above a lower explosive limit and below an upper explosive limit.

6. The method according to claim 1, further including monitoring a level of vibrations proximate the first site location.

7. The method according to claim 6, further including terminating the operation of the at least one laser source when detected vibrations exceed a baseline or threshold indicative of an explosion.

8. The method according to claim 1, wherein said operating includes operating a first laser source to project a first line extending from the first site location and operating a second laser source to project a second line extending from the site location.

9. The method according to claim 1, wherein the at least one laser source includes a plurality of lasers coupled to a computer controlled projector by at least one cable including an optical waveguide for supplying optical energy from the lasers to the projector.

10. The method according to claim 9, wherein operating the at least one laser source includes operating respective subsets of the plurality of lasers in round-robin fashion throughout the site activity period.

11. The method according to claim 1, wherein the site activity period is of sufficient length for the operating to be performed under both day and night ambient light operating conditions.

12. The method according to claim 1, wherein the operating comprises projecting at least one lane extending between a first site location and a second site location over the site activity period

13. An apparatus for continuously providing at least one visible line for a duration of a site activity period, wherein each projected line extends from a first site location and is usable as a reference aid during at least one of approach to and departure from the first site location despite dynamically variable ambient lighting conditions, the apparatus comprising:
at least one laser source operative to direct optical energy at a wavelength of between 380 nm and 750 nm upon a surface proximate the first site location;
an ambient light sensor dimensioned and arranged to detect variations in an intensity of sunlight at the first site location so as to approximate an intensity of sunlight striking the surface;
a computer, including a processor and a memory, operatively associated with the ambient light sensor, the processor being operative to execute instructions stored in memory to select, responsive to detected changes in ambient light intensity, any of a same, decreased and increased laser power output in order to continuously maintain visibility of a projected line for the duration of the site activity period; and
a laser controller operatively associated with the at least one laser and communicatively coupled to the computer, the laser source controller being operative to modulate an output of the at least one laser source responsive to commands from the computer to any of maintain, decrease or increase an output of the at least one laser source.

14. The apparatus according to claim 13, wherein said laser controller is operable according to signals received from the computer, to dynamically vary an amount of optical energy delivered to the surface as necessary to remain in compliance with one of a Class 1 and Class IIIa mode of operation.

15. The apparatus according to claim 13, wherein said at least one laser source includes a projector head and at least one laser remotely located from and optically coupled to said projector head by at least one waveguide.

16. The apparatus according to claim 15, wherein each laser of said at least one has a power rating of between 10 W and 100 W.

17. The apparatus according to claim 15, wherein the at least one laser source includes a plurality of lasers coupled to a projector by a plurality of optical waveguides for supplying optical energy from the lasers to the projector.

18. The apparatus according to claim 17, wherein the processor is further operative to execute instructions for operating respective subsets of the plurality of lasers in round-robin fashion throughout the site activity period.

19. The apparatus according to claim 13, further including at least one one of a vibration sensor and a vapor sensor operatively associated with the computer, wherein the processor is responsive to detection of at least one of an explosive vapor and vibrations indicative of an explosion to initiate a powering off of the at least one laser source and laser controller.
